(19) United States
(12) Patent Application Publication
(10) Pub. No.: US 2026/0192527 A1
(43) Pub. Date: Jul. 9, 2026

(54) COMPOSITE COMPONENT

(71) Applicant: Invibio Device Component Manufacturing Limited, Thornton Cleveleys, Lancashire (GB)

(72) Inventor: Tongyu Wu, Thornton Cleveleys, Lancashire (GB)

(21) Appl. No.: 19/133,128

(22) PCT Filed: Nov. 16, 2023
(86) PCT No.: PCT/GB2023/053017

§ 371 Date: May 27, 2025

(30) Foreign Application Priority Data
Nov. 28, 2022 (GB) 2217792.7

(51) Int. Cl. B29C 70/08; B29C 70/34; B29K 105/08; B29K 105/10; B29L 31/00

(52) U.S. Cl. CPC B29C 70/081; B29C 70/083; B29C 70/345; B29K 2105/0881; B29K 2105/106; B29K 2105/107; B29L 2031/753

(57) ABSTRACT

The present invention provides a composite component (102, 202) adapted to resist bending about a bending axis (122, 210) during use. The composite component comprises a composite material formed from a plurality of composite plies having a polymer and reinforcement fibres. The plurality of composite plies are arranged in: a first group of composite plies (308, 408) arranged in a substantially anisotropic layup with the reinforcement fibres being oriented substantially perpendicular to the bending axis, a second group of composite plies (310, 410) arranged in a substantially anisotropic layup with the reinforcement fibres being oriented substantially perpendicular to the bending axis, and an intermediate group of composite plies (312, 412) arranged in a substantially quasi-isotropic layup and disposed between the first group of composite plies and the second group of composite plies.

The present invention relates to a composite component, for example an implantable medical device or a bracket. The present invention also relates to a method of manufacturing a composite component.

### BACKGROUND

Composite materials comprising polymer and reinforcement fibres are known. For example, carbon fibre has been used as a reinforcement fibre in various polymeric composite materials. Such composite materials may be used in a range of applications, including, for example, in the manufacture of medical devices. For example, such composite materials may be used to make implantable devices, such as orthopaedic implants.

Composite materials have an advantage over metal materials because they provide improved flexibility whilst maintaining the strength required for load bearing. In addition, implantable polymeric composite components are known to be less likely to cause bone deterioration in the patient.

Fracture fixation plates (also known as bone plates or trauma plates) may be used in surgery to fix bone fragments together and to realign bones and bone fragments. Fracture fixation plates typically include pre-formed screw holes for receiving fixing screws which attach the plate to bone.

Fracture fixation plates have typically been formed of surgical grade stainless steel or titanium. More recently, fracture fixation plates have been formed using fibre-reinforced composite materials, such as carbon-reinforced polyetheretherketone (PEEK). One way to form such composite components is by layering up composite tape layers (or plies) in the Z direction having varying orientations of carbon fibres in the X-Y direction into a mould. The resulting laminate may be compression moulded under heat and pressure to form a semi-finished composite component—a blank. Typically, the plies are arranged at different angles to provide a balanced, symmetrical composite material that has approximately even bending stiffness in all directions—i.e., a quasi-isotropic configuration. Additional features such as holes for screws, k-wires, or sutures can then be machined into the blank to form a finished plate. The axis of the screw holes are typically parallel to the Z direction but no greater than ±45 degrees relative to the Z-direction.

### BRIEF SUMMARY

In one aspect there is provided a composite component adapted to resist bending about a bending axis during use. The composite component includes a composite material formed from a plurality of composite plies having a polymer and reinforcement fibres. The plurality of composite plies are arranged in:
a first group of composite plies arranged in a substantially anisotropic layup with the reinforcement fibres being oriented substantially perpendicular to the bending axis,
a second group of composite plies arranged in a substantially anisotropic layup with the reinforcement fibres being oriented substantially perpendicular to the bending axis, and
an intermediate group of composite plies arranged in a substantially quasi-isotropic layup and disposed between the first group of composite plies and the second group of composite plies.

Advantageously, providing the first and second groups of composite plies with an anisotropic layup will increase the bending stiffness of the composite component. In particular, by positioning the first and second groups of composite plies either side of the intermediate group they will be subject to higher tension (and compression) during bending of the composite component, and the anisotropic layups of the first and second groups will provide improved bending stiffness as compared to other layups. The increased bending stiffness may be desirable, or such an arrangement may permit fewer composite plies to be used allowing the composite component to be thinner and lighter for a given bending stiffness. Meanwhile, the quasi-isotropic configuration of the intermediate group provides torsional and shear stiffness for the composite component. The combination of outwardly positioned anisotropic composite material (the first and second groups of composite plies) and an intermediate quasi-isotropic composite material (the intermediate group of composite plies) provides a composite component having good bending stiffness while maintaining torsional rigidity and other characteristics provided by the quasi-isotropic layup of the intermediate group of composite plies.

The composite component may also include one or more screw holes extending through the composite component for attaching the component using a screw in use. The one or more screw holes may be threaded. The one or more screw holes may be tapered.

In an example, in use, a screw head of the screw abuts a tapered surface of the one or more tapered screw holes. The tapered screw hole may have a larger diameter at one surface of the composite component (e.g., the top surface) than at an opposite surface of the composite component (e.g., the bottom surface). Tightening the screw head against the tapered screw hole will generate hoop strain and hoop stress around the screw hole. Due to the taper of the screw hole, the hoop strain (and therefore hoop stress) will be greater towards the smaller diameter side of the screw hole than towards the larger diameter side. This is because the screw head will created substantially even displacement through the tapered screw hole, and this creates higher strain where the screw hole is smaller.

In this example, the plurality of composite plies may be arranged such that the intermediate group of composite plies is offset towards the side of the tapered screw hole with the smaller diameter (e.g., towards the bottom surface of the composite component). Accordingly, the higher hoop strain and hoop stress created by the screw head is borne by the quasi-isotropic arrangement of the intermediate group of composite plies, which is more resistant to fracture than the anisotropic configurations of the first and second groups of composite plies.

The composite component may include a top surface and a bottom surface. The first group of composite plies may be disposed at or near the top surface. The second group of composite plies may be disposed at or near the bottom surface. Providing the first and second groups at the top and bottom surfaces will improve the bending stiffness as the anisotropic configurations of the first and second groups provide higher bending stiffness than the quasi-isotropic group of composite plies.

In examples, the intermediate group of composite plies may be centered on a mid-plane between the top surface and the bottom surface.

In other examples, the intermediate group of composite plies may be offset from a mid-plane between the top surface and the bottom surface. In examples, the intermediate group of composite plies may be offset towards the bottom surface. Therefore, the intermediate group of composite plies can be positioned, within the thickness of the composite component, to align with the region of higher hoop strain and hoop stress created by a screw head in a tapered screw hole of the composite component, as described above.

In examples, each composite ply includes a plurality of unidirectional reinforcement fibres. That is, each composite ply comprises a plurality of reinforcement fibres arranged substantially parallel to each other. Each composite ply may include some reinforcement fibres arranged in a non-parallel manner, for example to hold together the other reinforcement plies, but primarily the reinforcement plies are parallel and unidirectional.

In examples, each of the first group of composite plies and the second group of composite plies includes at least two composite plies, for example at least three composite plies, for example at least four composite plies, for example at least five composite plies.

In examples, the intermediate group of composite plies includes at least five composite plies, for example at least seven composite plies, for example at least eight composite plies.

In examples, the polymer of the composite material comprises polyaryletherketone. In examples, the reinforcement fibres of the composite material comprise carbon reinforcement fibres.

In examples, the composite component is elongate along a longitudinal axis that is substantially perpendicular to the bending axis.

In examples, the composite component is an implantable medical device.

In examples, the composite component is a bracket, for example a bracket for a vehicle such as an aerospace vehicle, an aircraft, a road vehicle, or a rail vehicle.

In examples, the composite component is planar. In other examples, the composite component is non-planar. The composite component may be compression moulded.

In a second aspect, there is provided a composite component that includes a composite material formed from a plurality of composite plies that comprise a polymer and reinforcement fibres. The plurality of composite plies are arranged between a top surface and a bottom surface, and a tapered screw hole extends through the composite component, the tapered screw hole having a smaller diameter at the bottom surface than at the tope surface. The plurality of composite plies are arranged in:
a first group of composite plies disposed at or near the top surface,
a second group of composite plies disposed at or near the bottom surface, and
an intermediate group of composite plies disposed between the first group of composite plies and the second group of composite plies.

The intermediate group of composite plies includes a quasi-isotropic layup. The intermediate group of composite plies is offset from a mid-plane between the top surface and the bottom surface towards the bottom surface.

Tightening the screw head will generate hoop strain and hoop stress around the screw hole. Due to the taper of the tapered screw hole, the hoop strain (and therefore hoop stress) will be greater towards the smaller diameter side of the screw hole (i.e., the bottom surface) than towards the larger diameter side 9 i.e., the top surface). This is because the screw head will created substantially even displacement through the tapered screw hole, and this creates higher strain where the screw hole is smaller.

Advantageously, the intermediate group of composite plies is offset towards the smaller diameter side of the tapered screw hole (i.e., towards the bottom surface). The quasi-isotropic configuration of the intermediate group of composite plies is better able to withstand the larger hoop strain/stress, so this offset can improve the performance of the composite component.

In examples, the intermediate group of composite plies includes a symmetrical layup.

In examples, the first group of composite plies includes a substantially anisotropic layup, for example a unidirectional layup. In examples, the second group of composite plies includes a substantially anisotropic layup, for example a unidirectional layup. In examples, during use, the composite component is subject to bending about a bending axis. In such examples, the first group of composite plies and/or the second group of composite plies may be oriented such that the reinforcement fibres are substantially perpendicular to the bending axis. In this way, the first and second groups of composite plies provide improved bending stiffness. In examples, each composite ply includes a plurality of unidirectional

reinforcement fibres. That is, each composite ply comprises a plurality of reinforcement fibres arranged substantially parallel to each other. Each composite ply may include some reinforcement fibres arranged in a non-parallel manner, for example to hold together the other reinforcement plies, but primarily the reinforcement plies are parallel and unidirectional.

In examples, each of the first group of composite plies and the second group of composite plies includes at least two composite plies, for example at least three composite plies, for example at least four composite plies, for example at least five composite plies.

In examples, the intermediate group of composite plies includes at least five composite plies, for example at least seven composite plies, for example at least eight composite plies.

In examples, the polymer of the composite material comprises polyaryletherketone. In examples, the reinforcement fibres of the composite material comprise carbon reinforcement fibres.

In examples, the composite component is elongate along a longitudinal axis that is substantially perpendicular to the bending axis.

In examples, the composite component is an implantable medical device.

In examples, the composite component is a bracket, for example a bracket for a vehicle such as an aerospace vehicle, an aircraft, a road vehicle, or a rail vehicle.

In examples, the composite component is planar. In other examples, the composite component is non-planar. The composite component may be compression moulded.

In a third aspect, there is provided a method of manufacturing a composite component. The method includes providing a plurality of composite plies that each include a polymer and reinforcement fibres. The method further includes laying up the plurality of composite plies in:
a first group of composite plies in an anisotropic configuration,
an intermediate group of composite plies in a quasi-isotropic configuration, and
a second group of composite plies in an anisotropic configuration parallel to the first group.

The intermediate group of composite plies is in between the first group of composite plies and the second group of composite plies.

The method is therefore a method of manufacturing the composite component of the first and second aspects described above.

In examples, the method may also include machining a screw hole through the composite component. The screw hole may be threaded. The screw hole may be tapered.

In examples, the method comprises laying up the plurality of composite plies such that the intermediate group of composite plies is centred on a mid-plane between top and bottom surfaces of the composite component.

In other examples, the method comprises laying up the plurality of composite plies such that the intermediate group of composite plies is offset relative to a mid-plane between top and bottom surfaces of the composite component. In such examples, the intermediate group of composite plies is offset towards a bottom surface of the composite component.

In examples, the method may also include compression moulding the plurality of composite plies.

In examples, the composite component is an implantable medical device.

In examples, the composite component is a bracket, for example a bracket for a vehicle such as an aerospace vehicle, an aircraft, a road vehicle, or a rail vehicle.

In examples, the composite component is planar. In other examples, the composite component is non-planar. The composite component may be compression moulded.

Other technical features may be readily apparent to one skilled in the art from the following figures, descriptions, and claims.

As used herein, the term “anisotropic” means that the composite material has different strength and stiffness in different directions through the material. In particular, as described herein, some parts of the composite material have an anisotropic configuration provided by a unidirectional arrangement of the reinforcement fibres within the composite plies. Within the anisotropic configuration of the composite plies the reinforcement fibres are primarily parallel to each other, giving greater strength and stiffness about a bending axis perpendicular to the direction of the reinforcement fibres. However, it will be appreciated that within the anisotropic configuration of the composite plies the reinforcement fibres do not all have to parallel to each other, and there may be some reinforcement fibres arranged in a different orientation, for example to hold the other reinforcement fibres in position or to provide some torsional stiffness.

As used herein, the term “unidirectional” means that the reinforcement fibres are primarily parallel to each other, although it will be appreciated that some reinforcement fibres within a unidirectional layup may have a different orientation, for example to hold the other reinforcement fibres in position or to provide some torsional stiffness.

As used herein, the term “quasi-isotropic” means that the composite material has substantially isotropic properties within the plane of the composite material. That is, the strength and stiffness of the quasi-isotropic composite material is substantially the same in any direction within the plane of the composite material. This is typically achieved by providing reinforcement fibres at different angles within the layup, preferably in a balanced and symmetrical manner. However, it will be appreciated that the quasi-isotropic composite material need not be entirely isotropic within the plane of the composite material, and may instead have directions of higher strength and stiffness than in other directions. For example, a layup comprising reinforcement fibres at 0 degrees and 90 degrees to the bending axis may be considered quasi-isotropic. Similarly, a quasi-isotropic layup may comprise reinforcement fibres at +/−45 degrees, +/−90 degrees and 0 degrees to the bending axis, or reinforcement fibres at +/−22.5 degrees, +/−45 degrees, +/−90 degrees and 0 degrees to the bending axis, or reinforcement fibres at +/−30 degrees, +/−60 degrees, and 0 degrees to the bending axis.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

The invention will now be described with reference to the accompanying drawings, in which:

FIG. 1A illustrates a composite component, particularly a fracture fixation plate.

FIG. 1B illustrates a cross-section of a screw hole of the composite component of FIG. 1A.

FIG. 2 illustrates a further example composite component, in particular a bracket.

FIG. 3 illustrates a cross-section of a first example composite material of the composite components of FIGS. 1A, 1B, and 2.

FIG. 4 illustrates a cross-section of a second example composite material of the composite components of FIGS. 1A, 1B, and 2.

### DETAILED DESCRIPTION

As described below, the invention relates to a composite component formed from a composite material. The composite material is a polymeric composite formed of a polymer and reinforcement fibres.

### Polymer

In preferred examples, the polymer of the composite material is a polyaryletherketone. Any suitable polyaryletherketone may be used in the composite material of the present invention. Suitable polyaryletherketone may have repeating units of formula (I) below:

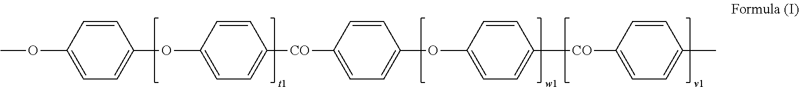

where t1 and w1 are independently represent 0 or 1 and v1 represents 0, 1 or 2.

The polyaryletherketone suitably includes at least 90, 95 or 99 mol % of repeat unit of formula (I).

The polyaryletherketone may comprise or consist essentially of a repeat unit of formula (I). Preferred polymeric materials comprise (or consist essentially of) a said repeat unit wherein t1=1, v1=0 and w1=0; t1=0, v1=0 and w1=0; t1=0, w1=1, v1=2; or t1=0, v1=1 and w1=0. More preferably, the polyaryletherketone comprises (e.g. consists essentially of) the repeat unit I, wherein t1=1, v1=0 and w1=0; or t1=0, v1=0 and w1=0. The most preferred polyaryletherketone comprises (especially consists essentially of) a said repeat unit wherein t1=1, v1=0 and w1=0.

In preferred embodiments, the polyaryletherketone is selected from polyetheretherketone, polyetherketone, polyetherketoneetherketoneketone and polyetherketoneketone. In a more preferred embodiment, the polyaryletherketone is polyetheretherketone or PEEK.

In some examples, the polyaryletherketone (e.g. PEEK) may have a Notched Izod Impact Strength (specimen 80 mm×10 mm×4 mm with a cut 0.25 mm notch (Type A), tested at 23° C., in accordance with ISO180) of at least 4 KJmT⁻², preferably at least 5 KJmT⁻², more preferably at least 6 KJmT⁻². The Notched Izod Impact Strength, measured as described above, may be less than 10 KJmT⁻², suitably less than 8 KJmT⁻². The Notched Izod Impact Strength, measured as described above, may be at least 3 KJmT⁻², suitably at least 4 KJmT⁻², preferably at least 5 KJmT⁻². The Notched Izod Impact Strength may be less than 50 KJmT⁻², suitably less than 30 KJmT⁻².

The polyaryletherketone (e.g. PEEK) suitably has a melt viscosity (MV) of at least 0.06 kNsm⁻², preferably has a MV of at least 0.09 kNsm⁻², more preferably at least 0.12 kNsm⁻². The polyaryletherketone (e.g. PEEK) may have a MV of less than 1.00 kNsm⁻², preferably less than 0.5 kNsm⁻².

The polyaryletherketone (e.g. PEEK) may have a MV in the range 0.09 to 0.5 kNsm⁻², preferably in the range 0.1 to 0.3 kNsm⁻², preferably having a MV in the range 0.1 to 0.2 kNsm⁻². An MV of 0.15 kNsm⁻² has been found to be particularly advantageous. MV is suitably measured using capillary rheometry operating at 400° C. at a shear rate of 1000 s-1 using a tungsten carbide die, 0.5 mm×3.175 mm.

In a preferred embodiment, the polyaryletherketone (e.g. PEEK) has a melt viscosity (MV) of 0.09 kNsm⁻² to 0.5 kNsm⁻².

The polyaryletherketone (e.g. PEEK) may be amorphous or semi-crystalline. The polyaryletherketone is preferably crystallizable. The polyaryletherketone is preferably semi-crystalline. The level and extent of crystallinity in a polymer is preferably measured by wide angle X-ray diffraction (also referred to as Wide Angle X-ray Scattering or WAXS), for example as described by Blundell and Osborn (Polymer 24, 953, 1983). Alternatively, crystallinity may be assessed by Differential Scanning calorimetry (DSC).

The level of crystallinity of said polyaryletherketone (e.g. PEEK) may be at least 1%, suitably at least 3%, preferably at least 5% and more preferably at least 10%. In especially preferred embodiments, the crystallinity may be greater than 25%. It may be less than 50% or less than 40%.

The main peak of the melting endotherm (Tm) of the polyaryletherketone (if crystalline) may be at least 300° C. Where e.g. PEEK is used, the main peak of the melting endotherm (Tm) may be at least 300° C.

The composite material may comprise any suitable amount of the polyaryletherketone (e.g. PEEK). For example, the composite material may comprise at least 20 volume %, preferably at least 25 volume %, more preferably at least 30 volume %, yet more preferably at least 35 volume %, even more preferably at least 37 volume % and most preferably at least 39 volume % polyaryletherketone (e.g. PEEK). The composite material comprises up to 48 volume % polyaryletherketone (e.g. PEEK). In some embodiments, the composite material may comprise up to 45 volume %, up to 43 volume % polyaryletherketone (e.g. PEEK).

In some embodiments, the composite material may comprise 20 to 48 volume %, preferably 30 to 48 volume %, more preferably 35 to 48 volume %, yet more preferably 37 to 48 volume % or 38 to 48 volume % polyaryletherketone (e.g. PEEK). More preferably, the composite material may comprise 39 to 48 volume %, even more preferably 39 to 45 volume % polyaryletherketone (e.g. PEEK). In some embodiments, the composite material may comprise 39 to 43 volume % polyaryletherketone (e.g. PEEK).

The volume ratio of reinforcement fibre to polyaryletherketone (e.g. PEEK) is 1.1:1 to 1.5:1, for example, 1.2:1 to 1.4:1.

### Reinforcement Fibres

Any suitable reinforcement fibre may be used. The fibres used may be selected from inorganic or organic fibrous materials. The fibres may have a melting or decomposition temperature of greater than 200° C., for example, greater than 250° C. or greater than 300° C. In some embodiments, the fibres may have a melting temperature of greater than 350° C. or 500° C. Examples of suitable fibres include aramid fibres, carbon fibre, glass fibre, silica fibre, zirconia fibre, silicon nitride fibre, boron fibre and potassium titanate fibre. Most preferred fibres are carbon fibres.

The reinforcement fibre (e.g. carbon fibre) may have a tensile strength of greater than 4,200 MPa, preferably greater than 4,500 MPa, more preferably greater than 4,800 MPa.

The reinforcement fibre (e.g. carbon fibre) may have a tensile modulus of greater than 200 GPa, preferably greater than 230 GPa, more preferably greater than 240 GPa.

The reinforcement fibre (e.g. carbon fibre) may have a strain at failure of greater than 1.1%, preferably, greater than 1.2%, 1.4% or 1.6% The reinforcement fibre (e.g. carbon fibre) may have a strain at failure of less than 2.2%, for instance, less than 2.0% or 1.9%. In some embodiments, reinforcement fibre (e.g. carbon fibre) may have a strain at failure of 1.2 to 2.2%, for example, 1.4 to 2.0% or 1.6 to 1.9%. In one embodiment, the reinforcement fibre (e.g. carbon fibre) may have a strain at failure of 1.7 to 1.9%.

The reinforcement fibre (e.g. carbon fibre) may have a mass per unit length of 0.1 to 1.0 g/m, for example, 0.2 to 0.8 g/m. In some embodiments, the 0.2 to 0.5 g/m.

The reinforcement fibre (e.g. carbon fibre) may have a density of greater than 1.65 g/cm³, preferably greater than 1.70 g/cm³. The reinforcement fibre (e.g. carbon fibre) may have a density of less than 1.85 g/cm³, preferably less than 1.80 g/cm³. In some embodiments, the reinforcement fibre (e.g. carbon fibre) may have a density of 1.70 to 1.85 g/cm³, for example, 1.75 to 1.80 g/cm³, or 1.78 to 1.79 g/cm³.

The reinforcement fibre (e.g. carbon fibre) may be provided in the form of a continuous tow. Any suitable tow size may be used. The tow size indicates the number of filaments in the tow. In some embodiments, the tow size may be 1,000 to 24,000. In one embodiment, a tow size of 6,000 to 12,000 may be employed.

Examples of suitable reinforcement fibre include carbon fibres supplied, for example, by Hexcel® under the trademark HexTow®.

As noted above, the composite material of the present invention comprises polyaryletherketone, and reinforcement fibres.

The composite material may be formed as a sheet or tape, known as a ply. For example, the reinforcement fibre (e.g. carbon fibre) may be combined with the polyaryletherketone (e.g. PEEK) and formed into a composite ply. The ply may be formed, for example, using heat and/or compression. In an embodiment, the polyaryletherketone (e.g. PEEK) may be heated to above its softening or melting temperature to melt or soften the polymer around the fibres to form the composite material. The molten or soften polymer is then compressed around the fibres to form the ply.

When heat is applied, suitable temperatures include temperatures of 320° C. and above, preferably, of 330° C. and above, more preferably, of 340° C. and above. In some embodiments, compression moulding may be carried out at temperatures of 320 to 450° C., preferably 330 to 400° C., more preferably 340 to 380° C. and yet more preferably 350 to 370° C. Suitably, pressures of at least 1.5 MPa or at least 2 MPa may be applied. Examples of suitable pressures range from 1.5 to 10 MPa, for instance, 2 to 8 MPa.

The composite ply formed using the composite material of the present invention may have a thickness of 10 microns to 1 mm, preferably 100 to 300 microns, more preferably 140 to 200 microns.

The composite ply may be used to form a composite component, for example, a medical implant or bracket as explained below.

### Composite Component

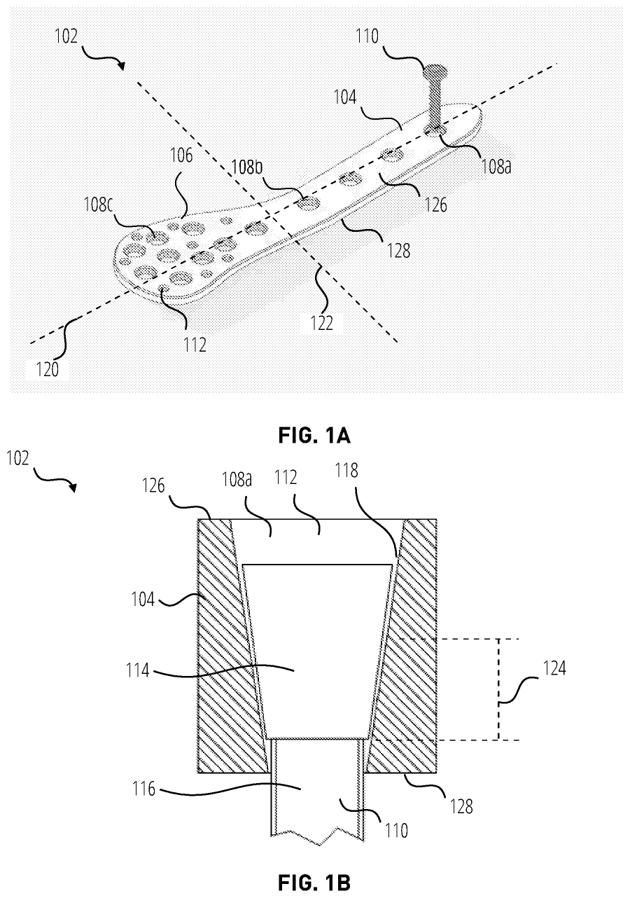

FIG. 1A shows a composite component, in particular a fracture fixation plate 102. In use, the fracture fixation plate 102 is attached to a bone, bone parts and/or bone fragments. The fracture fixation plate 102 is attached across a bone fracture to hold the bone in place and facilitate healing.

The illustrated example fracture fixation plate 102 has a generally elongate form, with a first end 104 and a second end 106 arranged along a longitudinal axis 120. The fracture fixation plate 102 has a top surface 126 and a bottom surface, in particular a bone facing surface 128. In use, the bone facing surface 128 is placed against the bone.

The first end 104 is screwed to a first side of the bone fracture and the second end 106 is screwed to the second side of the bone fracture. Screw holes 108 are used to screw the fracture fixation plate 102 to the bone and bone fragments. Only a single screw 110 is shown but it will be appreciated that multiple screws are used. The fracture fixation plate 102 has a plurality of screw holes 108a, 108b, 108c and the surgeon can select which to use during surgery, depending on the bone shape, integrity, and location of the fracture and any bone fragments. Additional screw holes 112 may be provided in the first end 104 and/or the second end 106, for example for smaller screws used for smaller screws for smaller bone fragments.

After the fracture fixation plate 102 has been attached across the bone fracture it is subjected to bending stresses as the patient moves and applies load to the bone and the fracture fixation plate 102. The bending stress is generally applied about a bending axis 122 that is perpendicular to the longitudinal axis 120. As illustrated, the bending axis 122 may be approximately at the divide between the first end 104 and the second end 106, but may be anywhere along the fracture fixation plate 102, depending on the nature of the fracture and the relative location of the fracture fixation plate 102 on the bone. In addition, it will be appreciated that the bending axis 122 may be in the plane of the fracture fixation plate 102, as illustrated, or it may be offset from the fracture fixation plate 102, for example towards or away from the bone, depending on the geometry of the fracture and the bone, and the use of bone during patient movements.

Once attached across the bone fracture the fracture fixation plate 102 is configured to hold the ends of the fractured bone in close proximity while permitting a small degree of movement through flexure. The fracture fixation plate 102 therefore holds the bones in place and bears the load applied to the bone, while the flexure encourages bone healing.

The fracture fixation plate 102 may be planar (i.e., flat), but typically has a profile to match the bone to which it is attached. The size, shape and profile of the fracture fixation plate 102 can be adapted for the specific bone on which it will be used. For example, a fracture fixation plate 102 for a fractured humerus would be smaller, and thinner, than a fracture fixation plate 102 for a fractured femur, because the bones are different size and shape and because the fracture fixation plate 102 would be subjected to different magnitudes of loading once attached.

As described in more detail hereinafter, the fracture fixation plate 102 is formed from a composite material having a polymer and reinforcement fibres. The composite material is formed from a plurality of composite plies. Each composite ply comprises reinforcement fibres and a polymer. The composite plies are laid up and then compression moulded to fuse together the plies by melting or softening the polymer, creating a coherent composite material. The form of the mould dictates the profile of the composite material and fracture fixation plate 102, allowing the fracture fixation plate 102 to be planar or non-planar.

In other examples, the composite component illustrated in FIG. 1A may be another type of orthopaedic implant, an intramedullary nail, a spinal implant such as a cage, rod or screw, or other load bearing implantable component.

FIG. 1B shows a cross-section through the fracture fixation plate 102 at screw hole 108a. The same cross-section applies to screw hole 112. As shown, the screw hole 108a, 112 is tapered, having a larger diameter at the top surface 126 than at the bone facing surface 128. The screw hole 108a, 112 has a tapered screw hole surface 118. In some examples, the screw hole 108a, 112 may be threaded. In other examples the screw hole 108a, 112 may be a plain through hole (i.e., not threaded). The screw hole 108a, 112 may be machined after forming the composite material.

A screw 110 is positioned in the screw hole 108a, 112. The screw 110 has a screw shaft 116 that is threaded. If the screw hole 108a, 112 is threaded then the screw shaft 116 may threadingly engage at least a part of the screw hole 108a, 112. Similarly, if the screw hole 108a, 112 is threaded then the screw head 114 may be at least partially threaded and may threadingly engage at least a part of the thread of the screw hole 108a, 112. The screw shaft 116 engages the underlying bone to attach the fracture fixation plate 102 to the bone.

As shown, the screw 110 includes a screw shaft 116 and a screw head 114 that is received in the screw hole 108a. The screw head 114 has a tapered profile that matches the screw hole 108a, 112 and abuts the tapered screw hole surface 118. The abutment between the screw head 114 and the tapered screw hole surface 118 imparts a hoop strain on the fracture fixation plate 102 at the screw hole 108a, 112 by pushing the composite material outwards where the screw head 114 contacts the screw hole 108a. As a result of the taper of the screw head 114 and the tapered screw hole surface 118, the hoop strain is greater towards the smaller diameter side of the screw hole 108a, i.e., towards bone facing surface 128. In particular, the hoop strain applied to the fracture fixation plate 102 is greatest in the region of higher hoop strain 124 illustrated in FIG. 1B. As shown in FIG. 1B, the region of higher hoop strain 124 is offset towards the bone facing surface 128 (i.e., closer to the bone facing surface 128 than to the top surface 126). The higher hoop strain applied in the region of higher hoop strain 124 will impart a greater hoop stress at this location.

In other examples, depending on the relative sizes of the screw hole 108a, 112 and the screw 110, particularly the screw head 114, the region of higher hoop strain 124 may be at a different position between the top surface 126 and the bone facing surface 128.

In some examples, the screw holes 108a, 108b, 108c, 112 of the fracture fixation plate 102 may not be tapered, and may be straight through holes in the fracture fixation plate 102.

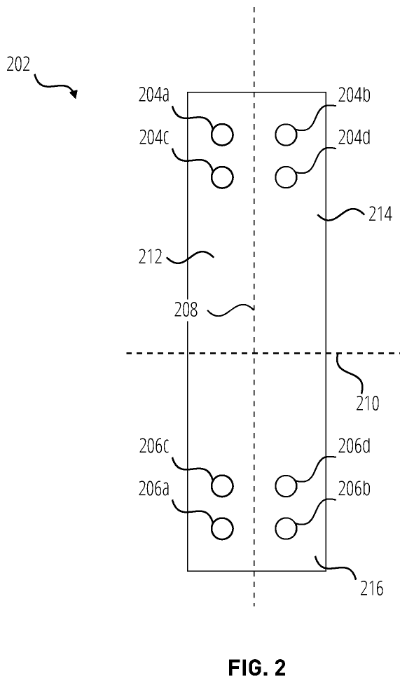

In the example of FIG. 2 the composite component is a bracket 202. The bracket 202 may be used in a vehicle, for example an aerospace vehicle, an aircraft, a road vehicle or a rail vehicle. The bracket 202 is generally elongate along longitudinal axis 208. The bracket may be planar or non-planar, for example the bracket 202 may include a bend. The bracket 202 has a top surface 212 and an opposing bottom surface, which is not shown in FIG. 2.

The bracket 202 includes a first end 214 having a plurality of screw holes 204a, 204b, 204c, 204d. The bracket 202 includes a second end 216 having a plurality of screw holes 206a, 206b, 206c, 206d. The screw holes 204a, 204b, 204c, 204d, 206a, 206b, 206c, 206d are used to attach the bracket 202 to further components. The bracket 202 may be attached to the further components on its top surface 212 and/or on its bottom surface.

During use, when the bracket 202 is attached to the further components, the bracket 202 may be subject to bending stress applied generally about bending axis 210. As illustrated, the bending axis 210 may be approximately perpendicular to the longitudinal axis 208. However, in some applications the bending axis 210 may be otherwise oriented relative to the longitudinal axis 208.

The screw holes 204a, 204b, 204c, 204d, 206a, 206b, 206c, 206d of the bracket 202 may be tapered, as described with reference to FIG. 1B. Alternatively, the screw holes 204a, 204b, 204c, 204d, 206a, 206b, 206c, 206d of the bracket 202 may be straight through holes. In some examples, the screw holes 204a, 204b, 204c, 204d, 206a, 206b, 206c, 206d of the bracket 202 may be threaded. In other examples, the screw holes 204a, 204b, 204c, 204d, 206a, 206b, 206c, 206d of the bracket 202 may be plain (i.e., not threaded).

As described in more detail hereinafter, the bracket 202 is formed from a composite material having a polymer and reinforcement fibres. The composite material is formed from a plurality composite plies. Each composite ply comprises reinforcement fibres and a polymer. The composite plies are laid up and then compression moulded to fuse together the plies by melting or softening the polymer, creating a coherent composite material. The form of the mould dictates the profile of the composite material and bracket 202, allowing the bracket 202 to be planar or non-planar.

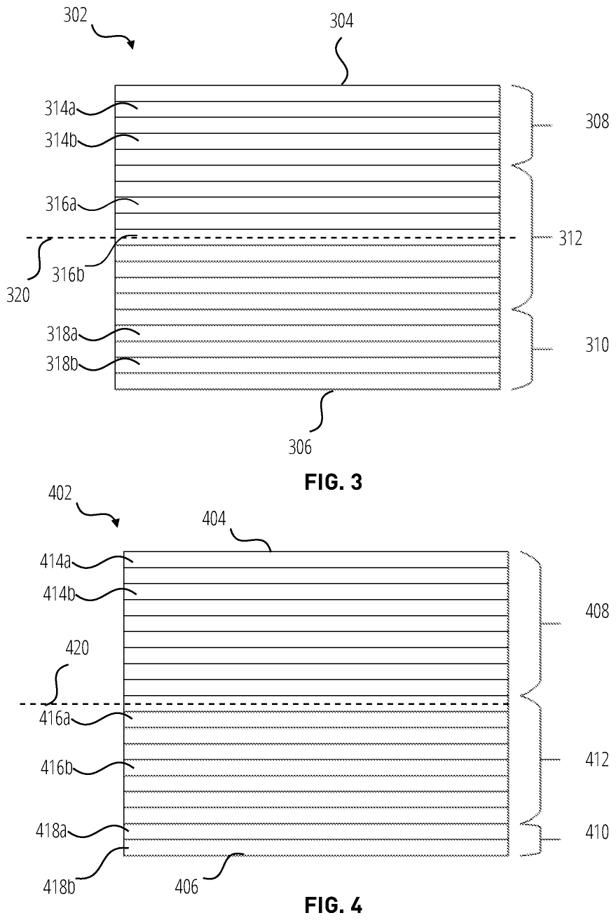

FIG. 3 shows a first example layup of the composite material 302 of the fracture fixation plate 102 of FIG. 1A and FIG. 1B, and/or the bracket 202 of FIG. 2. As illustrated, the composite material 302 comprises a plurality of composite plies 314a, 314b, 316a, 316b, 318a, 318b. Each composite ply 314a, 314b, 316a, 316b, 318a, 318b comprises a plurality of reinforcement fibres, in particular carbon fibres, and a polymer. In each composite ply 314a, 314b, 316a, 316b, 318a, 318b the reinforcement fibres are arranged in a unidirectional manner, i.e., substantially parallel to each other. In particular, in each composite ply 314a, 314b, 316a, 316b, 318a, 318b a majority of the reinforcement fibres are parallel to each other. The composite plies 314a, 314b, 316a, 316b, 318a, 318b are arranged in a layup, illustrated in FIG. 3. Once laid up the assembled composite material 302 is heated and compressed to form the composite component, for example the fracture fixation plate 102 of FIG. 1A and FIG. 1B or the bracket 202 of FIG. 2.

As shown in FIG. 3, the composite plies 314a, 314b, 316a, 316b, 318a, 318b are arranged in:
a first group of composite plies 308 at the top surface 304 of the composite material 302,
a second group of composite plies 310 at the bottom surface 306 of the composite material 302, and
an intermediate group of composite plies 312 between the first group of composite plies 308 and the second group of composite plies 310.

The first group of composite plies 308 have an anisotropic layup. In particular, the composite plies 314a, 314b of the first group of composite plies 308 are arranged substantially unidirectionally. That is, the composite plies 314a, 314b of the first group of composite plies 308 are arranged such that a majority of their reinforcement fibres are substantially parallel to each other. The reinforcement fibres of the first group of composite plies 308 are arranged to be substantially parallel with the longitudinal axis 120, 208 of the fracture fixation plate 102 or bracket 202, respectively, as shown in FIG. 1 and FIG. 2. Accordingly, the first group of composite plies 308 primarily provides bending stiffness about the bending axis 122, 210 of the fracture fixation plate 102 or bracket 202, respectively.

Similarly, the second group of composite plies 310 have an anisotropic layup. In particular, the composite plies 316a, 316b of the second group of composite plies 310 are arranged unidirectionally. That is, the composite plies 316a, 316b of the second group of composite plies 310 are arranged such that a majority of their reinforcement fibres are substantially parallel to each other. The reinforcement fibres of the second group of composite plies 310 are arranged to be substantially parallel with the longitudinal axis 120, 208 of the fracture fixation plate 102 or bracket 202, respectively. Accordingly, the second group of composite plies 310 primarily provides bending stiffness about the bending axis 122, 210 of the fracture fixation plate 102 or bracket 202, respectively.

The intermediate group of composite plies 312 has a quasi-isotropic layup. That is, the composite plies 316a, 316b of the intermediate group of composite plies 312 are arranged at different orientations relative to each other, and relative to the longitudinal axis 120, 208 of the fracture fixation plate 102 or bracket 202, respectively. The intermediate group of composite plies 312 may comprise a balanced and/or symmetrical layup. The intermediate group of composite plies 312 therefore provides approximately even bending stiffness in each direction, and also provides torsional and shear stiffness at a degree not provided by the anisotropic configurations of the first group of composite plies 308 and the second group of composite plies 310.

In the illustrated example the composite material 302 comprises 19 composite plies, with the first group of composite plies 308 and the second group of composite plies 310 each having five composite plies 314a, 314b, 318a, 318b, and the intermediate group of composite plies 312 having nine composite plies 316a, 316b. However, in other examples there may be different numbers of composite plies in each group. In examples, the first group of composite plies 308, the second group of composite plies 310, and the intermediate group of composite plies 312 each comprise at least two composite plies, for example at least three composite plies, for example at least four composite plies, for example at least five composite plies. As illustrated, in this example the first group of composite plies 308 and the second group of composite plies 310 have the same number of composite plies, and therefore the intermediate group of composite plies 312 is centred on the mid-plane 320 of the composite material 302 (i.e., the middle of the intermediate group of composite plies 312 is aligned with the mid-point between the top surface 304 and the bottom surface 406).

In examples, all of the composite plies 314a, 314b, 318a, 318b of the first group of composite plies 308 and the second group of composite plies 310 are substantially parallel to each other. However, it will be appreciated that some of the composite plies 314a, 314b, 318a, 318b may have a different orientation, varying from parallel to the longitudinal axis 120, 208 of the composite component, while the first group of composite plies 308 and second group of composite plies 310 can still have a substantially anisotropic configuration. That is, the first group of composite plies 308 and the second group of composite plies 310 are primarily anisotropic, with a majority of the reinforcement fibres being parallel to each other and to the longitudinal axis 120, 208 of the composite component, but this does not exclude a minority of the reinforcement fibres having a different orientation.

As explained above, the intermediate group of composite plies 312 has a quasi-isotropic configuration. In examples, the intermediate group of composite plies 312 may comprise composite plies with reinforcement fibres oriented, relative to the longitudinal axis 120, 208 of the fracture fixation plate 102 and bracket 202, respectively, at +/−45 degrees, +/−90 degrees, and 0 degrees. In other examples, the intermediate group of composite plies 312 may comprise a quasi-isotropic layup having composite plies with reinforcement fibres oriented, relative to the longitudinal axis 120, 208 of the fracture fixation plate 102 and bracket 202, respectively, at +/−22.5 degrees, +/−45 degrees, +/−90 degrees, and 0 degrees. In other examples, the intermediate group of composite plies 312 may comprise a quasi-isotropic layup having composite plies with reinforcement fibres oriented, relative to the longitudinal axis 120, 208 of the fracture fixation plate 102 and bracket 202, respectively, at +/−30 degrees, +/−60 degrees, and 0 degrees. It will be appreciated that a quasi-isotropic layup may comprise composite plies with reinforcement fibres at different orientations in order to provide approximately even bending stiffness in any direction, which also provides higher torsional and shear stiffness.

It will also be appreciated that additional composite plies may be provided between the first group of composite plies 308 and the top surface 304, and/or between the second group of composite plies 310 and the bottom surface 306. Also, additional composite plies or groups of composite plies may be provided between the first group of composite plies 308 and the intermediate group of composite plies 312, and/or between the second group of composite plies 310 and the intermediate group of composite plies 312. Such additional composite plies or groups may provide surface finish or additional thickness to the composite material 302.

The anisotropic configuration of the first group of composite plies 308 and the second group of composite plies 310, and their positions at or near the top surface 304 and the bottom surface 306, provide improved bending stiffness compared to a fully quasi-isotropic layup. In particular, the parts of the composite material 302 positioned closest to the top surface 304 and the bottom surface 306 will experience the most tension and compression during bending, so providing anisotropic composite material at these locations increases the bending stiffness of the composite material 302.

Advantageously, referring to FIG. 1B and FIG. 3, the position of the intermediate group of composite plies 312 within the thickness of the composite material 302 may correspond to the region of higher hoop strain 124 illustrated in FIG. 1B. This may occur if (at least a lower part of) the screw head 114 of the screw 110 abuts the tapered screw hole surface 118 at the location of the intermediate group of composite plies 312 within the screw hole 108a, 112. Accordingly, the hoop stress is better handled by the composite material 302 as the quasi-isotropic configuration of the intermediate group of composite plies 312 is resistant to hoop stress, while the first group of composite plies 308 and the second group of composite plies 310 primarily provide increased bending stiffness.

FIG. 4 shows a further example layup of the composite material 402 of the fracture fixation plate 102 of FIG. 1A and FIG. 1B, and/or the bracket 202 of FIG. 2. As illustrated, the composite material 402 comprises a plurality of composite plies 414a, 414b, 416a, 416b, 418a, 418b. Each composite ply 414a, 414b, 416a, 416b, 418a, 418b comprises a plurality of reinforcement fibres, in particular carbon fibres, and a polymer. In each composite ply 414a, 414b, 416a, 416b, 418a, 418b the reinforcement fibres are arranged in a primarily unidirectional manner, i.e., substantially parallel to each other. The composite plies 414a, 414b, 416a, 416b, 418a, 418b are arranged in a layup, illustrated in FIG. 4. Once laid up the assembled composite material 402 is heated and compressed to form the composite component, for example the fracture fixation plate 102 of FIG. 1A and FIG. 1B or the bracket 202 of FIG. 2.

As shown in FIG. 4, the composite plies 414a, 414b, 416a, 416b, 418a, 418b are arranged in:
a first group of composite plies 408 at the top surface 404 of the composite material 402,
a second group of composite plies 410 at the bottom surface 406 of the composite material 402, and
an intermediate group of composite plies 412 between the first group of composite plies 408 and the second group of composite plies 410.

The first group of composite plies 408 have an anisotropic layup. In particular, the composite plies 414a, 414b of the first group of composite plies 408 are arranged unidirectionally. That is, the composite plies 414a, 414b of the first group of composite plies 408 are arranged such that a majority of their reinforcement fibres are substantially parallel to each other. The reinforcement fibres of the first group of composite plies 408 are arranged to be substantially parallel with the longitudinal axis 120, 208 of the fracture fixation plate 102 or bracket 202, respectively, as shown in FIG. 1 and FIG. 2. Accordingly, the first group of composite plies 408 primarily provides bending stiffness about the bending axis 122, 210 of the fracture fixation plate 102 or bracket 202, respectively.

Similarly, the second group of composite plies 410 have an anisotropic layup. In particular, the composite plies 416a, 416b of the second group of composite plies 410 are arranged unidirectionally. That is, the composite plies 416a, 416b of the second group of composite plies 410 are arranged such that a majority of their reinforcement fibres are substantially parallel to each other. The reinforcement fibres of the second group of composite plies 410 are arranged to be substantially parallel with the longitudinal axis 120, 208 of the fracture fixation plate 102 or bracket 202, respectively. Accordingly, the second group of composite plies 410 primarily provides bending stiffness about the bending axis 122, 210 of the fracture fixation plate 102 or bracket 202, respectively.

The intermediate group of composite plies 412 has a quasi-isotropic layup. That is, the composite plies 416a, 416b of the intermediate group of composite plies 412 are arranged at different orientations relative to each other, and relative to the longitudinal axis 120, 208 of the fracture fixation plate 102 or bracket 202, respectively. The intermediate group of composite plies 412 may comprise a balanced and/or symmetrical layup. The intermediate group of composite plies 412 therefore provides approximately even bending stiffness in each direction, and also provides a degree of torsional and shear stiffness not provided by the anisotropic configurations of the first group of composite plies 408 and the second group of composite plies 410.

In the illustrated example the composite material 402 comprises 19 composite plies 414a, 414b, 416a, 416b, 418a, 418b. The first group of composite plies 408 comprises nine composite plies 414a, 414b, and the second group of composite plies 410 comprises two composite plies 418a, 418b. The intermediate group of composite plies 412 has eight composite plies 416a, 416b. However, in other examples there may be different numbers of composite plies in each group. In examples, the first group of composite plies 408, the second group of composite plies 410, and the intermediate group of composite plies 412 each comprise at least two composite plies, for example at least three composite plies, for example at least four composite plies, for example at least five composite plies. In this example, the first group of composite plies 408 and the second group of composite plies 410 have different numbers of composite plies. Therefore, the intermediate group of composite plies 412 is offset relative to the mid-plane 420 of the composite material 402. In this example the intermediate group of composite plies 412 is offset from the mid-plane 420 of the composite material 402 towards the bottom surface 406. It will be appreciated that although offset from the mid-plane 420, the intermediate group of composite plies 412 still overlaps the mid-plane 420. In other examples the intermediate group of composite plies 412 may be offset to a greater degree so that there is no overlap between the intermediate group of composite plies 412 and the mid-plane 420.

In examples, all of the composite plies 414a, 414b, 418a, 418b of the first group of composite plies 408 and the second group of composite plies 410 are parallel to each other. However, it will be appreciated that some of the composite plies 414a, 414b, 418a, 418b may have a different orientation, varying from parallel with each other and to the longitudinal axis 120, 208 of the composite component, while the first group of composite plies 408 and second group of composite plies 410 can still have a substantially anisotropic configuration. That is, the first group of composite plies 408 and the second group of composite plies 410 are primarily anisotropic, with a majority of the reinforcement fibres being parallel to each other and to the longitudinal axis 120, 208 of the composite component, but this does not exclude a minority of the reinforcement fibres having a different orientation.

As explained above, the intermediate group of composite plies 412 has a quasi-isotropic configuration. In examples, the intermediate group of composite plies 412 may comprise composite plies with reinforcement fibres oriented, relative to the longitudinal axis 120, 208 of the fracture fixation plate 102 and bracket 202, respectively, at +/−45 degrees, +/−90 degrees, and 0 degrees. In other examples, the intermediate group of composite plies 412 may comprise a quasi-isotropic layup having composite plies with reinforcement fibres oriented, relative to the longitudinal axis 120, 208 of the fracture fixation plate 102 and bracket 202, respectively, at +/−22.5 degrees, +/−45 degrees, +/−90 degrees, and 0 degrees. In other examples, the intermediate group of composite plies 412 may comprise a quasi-isotropic layup having plies with reinforcement fibres oriented, relative to the longitudinal axis 120, 208 of the fracture fixation plate 102 and bracket 202, respectively, at +/−30 degrees, +/−60 degrees, and 0 degrees. It will be appreciated that a quasi-isotropic layup may comprise composite plies at different orientations in order to provide approximately even bending stiffness in any direction, which also provides torsional and shear stiffness.

It will also be appreciated that additional composite plies may be provided between the first group of composite plies 408 and the top surface 404, and/or between the second group of composite plies 410 and the bottom surface 406. Also, additional composite plies or groups of composite plies may be provided between the first group of composite plies 408 and the intermediate group of composite plies 412, and/or between the second group of composite plies 410 and the intermediate group of composite plies 412. Such additional composite plies or groups of composite plies may provide surface finish or additional thickness to the composite material 402.

The anisotropic configuration of the first group of composite plies 408 and the second group of composite plies 410, and their positions at or near the top surface 404 and the bottom surface 406, provide improved bending stiffness compared to a fully quasi-isotropic layup. In particular, the parts of the composite material 402 positioned closest to the top surface 404 and the bottom surface 406 will experience the most tension and compression during bending, so providing anisotropic composite fibres at these locations increases the bending stiffness of the composite material 402. Additionally, during use, for example when the fracture fixation plate 102 is affixed to a bone, the composite plies closer to the top surface 404 will be primarily placed under strain, than compression. Generally, the reinforcement fibres of the composite plies have a greater strength under tensile load than under compression, so having a higher number of composite plies in the first group of composite plies 408 than in the second group of composite plies 410 may provide improved bending stiffness for a given total number of composite plies.

Advantageously, referring to FIG. 1B and FIG. 4, the position of the intermediate group of composite plies 412 within the thickness of the composite material 402 may correspond to the region of higher hoop strain 124 illustrated in FIG. 1B. This may occur if (at least a lower part of) the screw head 114 of the screw 110 abuts the tapered screw hole surface 118 at the location of the intermediate group of composite plies 412 within the screw hole 108a, 112. That is, the region of higher hoop strain 124 may be aligned with the intermediate group of composite plies 412. Accordingly, the hoop stress is better handled by the composite material 402 as the quasi-isotropic configuration of the intermediate group of composite plies 412 is resistant to hoop stress, while the first group of composite plies 408 and the second group of composite plies 410 primarily provide increased bending stiffness. Offsetting the position of the intermediate group of composite plies 412 from the mid-plane 420 moves the intermediate group of composite plies 412 towards the smaller diameter side of the tapered screw hole 108a, further improving the ability of the composite material 402 to resist the hoop strain imparted by the screw head 114.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A composite component adapted to resist bending about a bending axis during use, the composite component comprising a composite material formed from a plurality of composite plies having a polymer and reinforcement fibres, the plurality of composite plies being arranged in:
a first group of composite plies arranged in a substantially anisotropic layup with the reinforcement fibres being oriented substantially perpendicular to the bending axis,
a second group of composite plies arranged in a substantially anisotropic layup with the reinforcement fibres being oriented substantially perpendicular to the bending axis, and
an intermediate group of composite plies arranged in a substantially quasi-isotropic layup and disposed between the first group of composite plies and the second group of composite plies.

2. The composite component of claim 1, further comprising one or more screw holes extending through the composite component for attaching the component using a screw in use.

3. The composite component of claim 2, wherein the one or more screw holes are threaded screw holes and/or the one or more screw holes are tapered.

4. (canceled)

5. The composite component of claim 2, wherein, in use, a screw head of the screw abuts a tapered surface of the one or more tapered screw holes, and wherein the plurality of composite plies are arranged such that the screw head abuts the intermediate group of composite plies.

6. The composite component of claim 1, comprising a top surface and a bottom surface.

7. The composite component of claim 6, wherein the first group of composite plies is disposed at or near the top surface and/or the second group of composite plies is disposed at or near the bottom surface.

8. (canceled)

9. The composite component of claim 6, wherein the intermediate group of composite plies is centred on a mid-plane between the top surface and the bottom surface.

10. The composite component of claim 6, wherein the intermediate group of composite plies is offset from a mid-plane between the top surface and the bottom surface, wherein the intermediate group of composite plies is offset towards the bottom surface.

11. (canceled)

12. A composite component comprising:
a composite material formed from a plurality of composite plies comprising a polymer and reinforcement fibres, the plurality of composite plies being arranged between a top surface and a bottom surface, and
a tapered screw hole extending through the composite component, the tapered screw hole have a smaller diameter at the top surface than at the bottom surface,
wherein the plurality of composite plies are arranged in:
a first group of composite plies disposed at or near the top surface,
a second group of composite plies disposed at or near the bottom surface, and
an intermediate group of composite plies disposed between the first group of composite plies and the second group of composite plies, the intermediate group of composite plies comprising a quasi-isotropic layup,
wherein the intermediate group of composite plies is offset from a mid-plane between the top surface and the bottom surface towards the bottom surface.

13. The composite component of claim 12, wherein the intermediate group of composite plies comprises a symmetrical layup.

14. The composite component of claim 12 or 13, wherein the first group and/or the second group of composite plies comprises a substantially anisotropic layup and wherein, during use, the composite component is subject to bending about a bending axis, and wherein the first group and/or the second group of composite plies is oriented such that the reinforcement fibres are substantially perpendicular to the bending axis.

15.-17. (canceled)

18. The composite component of claim 1, wherein each composite ply comprises a plurality of unidirectional reinforcement fibres.

19. The composite component of claim 1, wherein each of the first group of composite plies and the second group of composite plies comprises at least two composite plies.

20. The composite component of claim 1, wherein the intermediate group of composite plies comprises at least five composite plies.

21. The composite component of claim 1, wherein the composite component is elongate along a longitudinal axis that is substantially perpendicular to the bending axis.

22. The composite component of claim 1, wherein the composite component is an implantable medical device selected from a fracture fixation plate and a trauma plate.

23. (canceled)

24. The composite component of claim 1, wherein the composite component is a bracket.

25. The composite component of claim 1, wherein the composite component is non-planar.

26. The composite component of claim 1, wherein the composite component is compression moulded.

27. A method of manufacturing a composite component, comprising:
providing a plurality of composite plies comprising a polymer and reinforcement fibres,
laying up the plurality of composite plies in:
a first group of composite plies in an anisotropic configuration,
an intermediate group of composite plies in a quasi-isotropic configuration, and
a second group of composite plies in an anisotropic configuration parallel to the first group,
wherein the intermediate group of composite plies is in between the first group of composite plies and the second group of composite plies.

28.-30. (canceled)
